(19) United States
(12) Patent Application Publication
(10) Pub. No.: US 2007/0198351 A1
(43) Pub. Date: Aug. 23, 2007

(54) Marketing bar code method for distribution of promotional pieces

(75) Inventor: Thomas J. Cook, Arlington, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: United States Postal Service

(21) Appl. No.: 11/703,787

(22) Filed: Feb. 8, 2007

Related U.S. Application Data
(62) Division of application No. 10/362,505, filed on Feb. 24, 2003.

(51) Int. Cl. G07G 1/14

(52) U.S. Cl. 705/14

(57) ABSTRACT

A method of tracking parcels and assembling bulk mail parcels using barcodes.

### CROSS REFERENCE TO RELATED APPLICATION

The present application claims priority based on 35 U.S.C. §119 based on U.S. Provisional Application No. 60/229,603, filed Sep. 5, 2000, the complete disclosure of which is incorporated by reference.

### BACKGROUND OF THE INVENTION

1. Field of the Invention

The present invention relates to a method for assembling bulk mailing parcels, and, more particularly, for bulk mailing parcels containing one or more pieces to be returned to the sender, such as for example, discount coupons, post card orders, or responses to inquiries and the like.

2. Description of the Related Art

Currently, a bulk mailing customer applies for a permit at the United States Postal Service (USPS) to have a bulk mailing approved, and then engages a printer, for example, to print and stuff pieces of mail parcels that are appropriately addressed to individual mailing addresses. When a parcel includes discount coupons promoting a product or service, for example, the addressee may or may not use the coupons. When the coupons are used, they are ultimately returned to the bulk mailer or an agent of the bulk mailer to credit the retailer of the discounted goods or services. Because the conventional discount coupon contains no information as to the original bulk mailing parcel, the nature of the bulk mailing that contained the parcel, or the addressee of the parcel, subsequent bulk mailings must be made without benefit of information or complete analysis of prior mailings.

### SUMMARY OF THE INVENTION

The advantages and purpose of the invention will be set forth in part in the description which follows, and in part will be obvious from the description, or may be learned by practice of the invention. The advantages and purpose of the invention will be realized and attained by means of the elements and combinations particularly pointed out in the appended claims.

To attain the advantages and in accordance with the purpose of the invention, as embodied and broadly described herein, the invention comprises a method for assembling bulk mail parcels each containing at least one printed piece to be returned to the sender or the sender's designee. The method comprises the steps of printing a bar code on each of the printed pieces to be returned for each of the respective parcels, the bar code containing information including at least the mailing address of the parcel, and reading the bar code upon return of the printed piece to obtain information about an addressee of the parcel. Preferably, the bar code on each of the printed pieces differs in appearance from other bar codes used on the parcel.

In another aspect, the advantages and purpose of the invention are attained by a method for distributing at least one discount coupon to promote the sale of goods or services, the method including the steps of obtaining the name and address of a person to receive the at least one discount coupon, placing a bar code on the at least one discount coupon representing an encoded version of the name and address of the person, and reading the bar code to confirm that the person has used the at least one discount coupon. The coupon(s) may be distributed by mail or via the Internet and the address may be either one or both of a mailing address and an e-mail address.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 is a plan view of one embodiment of a discount coupon representing a mailing piece used in the practice of the present invention;

FIG. 2 is a plan view of an alternative embodiment of a discount coupon representing a mailing piece used in the practice of the present invention; and

FIG. 3 is a plan view of another alternative embodiment of a discount coupon representing a mailing piece used in the practice of the present invention;

### DESCRIPTION OF THE PREFERRED EMBODIMENT

Reference will now be made in detail to the exemplary embodiments of the invention, examples of which are illustrated in the accompanying drawings. Wherever possible, the same reference numbers will be used throughout the drawings to refer to the same or like parts.

In accordance with the present invention, each printed piece of a bulk mail parcel to be returned to the sender or the senders designee is printed with a bar code containing information including at least the mailing address of the parcel.

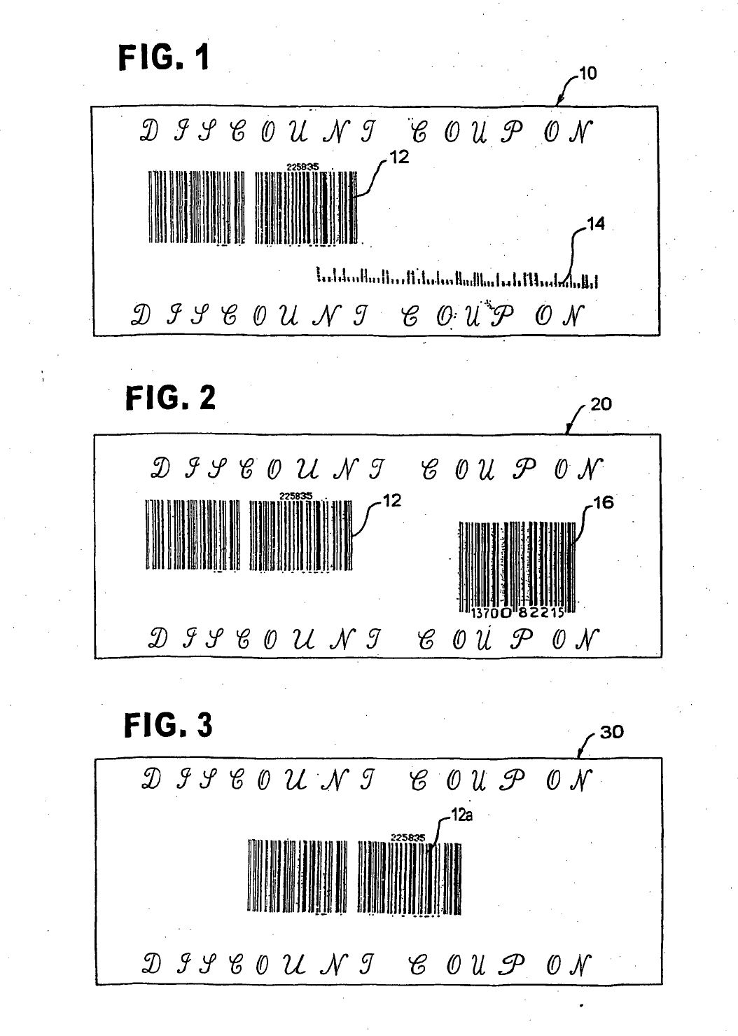

In FIG. 1 of the drawings, the printed piece is represented by a discount coupon 10. In addition to a conventional coupon bar code 12, the coupon 10 is printed with a postal numeric encoding technique (POSTNET) or Confirm®) bar code 14 representing a coded version of the mailing address of a person to whom a parcel containing the coupon 10 is to be mailed.

To print the bar code 14 on the pieces of a bulk mailing parcel, in this instance, the discount coupon 10, the USPS bulk mailing customer acquires the necessary data base and coding software from the USPS for use by the customer's printer. The mailing piece or pieces 10 can be printed concurrently with printing address labels or envelopes of the parcel containing the pieces 10. Alternatively, the pieces 10 and mailing labels or envelopes can be printed separately and thereafter collated by reading the bar codes 14 on the pieces and like bar codes on the mailing labels or envelopes, using reverse lookup software also provided by the USPS.

In FIG. 2 of the drawings, an alternative mailing piece is represented by a discount coupon 20 that also includes the conventional coupon bar code 12. In this embodiment, the coupon 20 is printed with a universal product code (UPC) bar code 16 representing a coded version of the mailing address of a person to whom a parcel containing the coupon 10 is to be mailed. Although the style or format of the UPC bar code 16 differs from the POSTNET or Confirm® bar code 14 of FIG. 1, it is coded to provide the same information.

In FIG. 3, a further alternative mailing piece is represented by a discount coupon 30.. In this embodiment a single coupon bar code 12a is modified so that it contains the same coded information as the conventional coupon bar code 12 of the previous embodiments, but, in addition, contains code representing the mailing address of a person to whom a parcel containing the coupon 30 is to be mailed.

In practicing the method of the present invention, the bulk mailer initially mails the parcels containing the address coded pieces to random addresses or to every address in specific zip codes. If the recipients of the mailing use the address coded pieces, such as by using the exemplary discount coupons at a retail outlet, the retail outlet returns the used coupon to the bulk mailer or its designee to receive payment for the amount of the discount coupon, for example. The bulk mailer may then read the address bar codes (14, 16, or 12a in the illustrated embodiments) and update its database for future bulk mailings. Once they build a database of those active clients using their product or service identified by address coded bar code, the bulk mailer will no longer be required to send out as many random address mailings or blanket every address in specific zip codes, since the updated database will include only those active clients using their product or service identified by address bar code. As a result, mailing costs are substantially reduced, since future mailings will be made only to individuals who have responded in the past, and are thus likely to respond to such future mailings.

In another embodiment of the invention, discount coupons may be distributed via the Internet. In this embodiment, a person desiring to download a coupon would be required to supply either one or both of a mailing address and an e-mail address as directed by a monitor screen prompt or fill-in form. Software then converts the supplied name and address to an encoded version represented by any one of the bar codes 12, 16, or 12a described above, and includes such a bar code on the downloaded coupon. Upon use of the downloaded coupon, the bar code is-read to confirm such use and the name and address of the person may be added to the vendor's database.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-5. (canceled)

6. A method for distributing at least one discount coupon to promote the sale of goods or services, comprising:
obtaining the name and address of a person to receive the at least one discount coupon;
placing a bar code on the at least one discount coupon representing an encoded version of the name and address of the person; and
reading the bar code to confirm that the person has used the at least one discount coupon.

7. The method of claim 6, wherein the at least one discount coupon is distributed by mail.

8. The method of claim 7, wherein the address is a mailing address.

9. The method of claim 6, wherein the at least one discount coupon is distributed via the internet.

10. The method of claim 9, wherein the address is at least one of a mailing address and an e-mail address.
